(19) United States
(12) Patent Application Publication
(10) Pub. No.: US 2017/0214611 A1
(43) Pub. Date: Jul. 27, 2017

(54) SIP HEADER CONFIGURATION FOR IDENTIFYING DATA FOR LANGUAGE INTERPRETATION/TRANSLATION

(71) Applicant: Language Line Services, Inc., Monterey, CA (US)

(72) Inventors: Jeffrey Cordell, Carmel, CA (US); James Boutcher, Carmel, CA (US); Lindsay D'Penha, Carmel, CA (US)

(73) Assignee: Language Line Services, Inc., Monterey, CA (US)

(21) Appl. No.: 15/003,730

(22) Filed: Jan. 21, 2016

(51) Int. Cl. H04L 12/741; H04L 29/06; H04M 7/00; G06F 17/28

(52) U.S. Cl. CPC H04L 45/74; G06F 17/2809; G06F 17/289; H04L 69/22; H04L 65/1006; H04M 7/006

(57) ABSTRACT

A computer implemented language interpretation/translation platform is provided. The computer implemented language interpretation/translation platform includes a receiver that receives a SIP packet. The SIP packet includes a request for a language interpretation/translation resource and a SIP header that stores identification data pertaining to the request. Further, the computer implemented language interpretation/translation platform includes a processor that selects the language interpretation/translation resource based on the identification data and routes the request to the selected language interpretation/translation resource.

### BACKGROUND

1. Field

This disclosure generally relates to the field of language interpretation/translation. More particularly, the disclosure relates to computer implemented language interpretation/translation platforms that provide language interpretation/translation services.

2. General Background

Current language interpretation/translation service providers provide the ability for customers to interact with a language interpreter or a translator. Such language interpretation/translation services are often helpful in a variety of contexts, e.g., medical, business, etc. For instance, such language interpretation/translation services allow a person with limited English proficiency (“LEP”) to communicate effectively with an English speaking person via a language interpreter.

Current language interpretation/translation platforms, which may be computer implemented, may be utilized to connect a user to a corresponding language interpreter/translator. Yet, such platforms often typically require a user to go through a cumbersome process to get connected to that particular language interpreter/translator. For example, users typically place a telephone call to a language interpretation service provider and have to provide various information, e.g., customer identifiers, PINs, requested languages for interpretation, account information, etc. prior to obtaining access to language interpretation/translation resources. Some platforms allow a user to press various buttons to generate DTMF tones to provide such information. Other platforms allow a user to communicate such information through an interactive voice response (“IVR”) system that automatically interacts with customers.

Such interactions are often considered by many customers to be too time consuming and repetitive as each IVR interaction often asks for similar customer information. Further, customers often have to remember such identifying information. Therefore, utilization of the IVR system to obtain language interpretation/translation services is often a cumbersome process for users. Thus, current language interpretation/translation platforms often have difficulty providing language interpretation/translation services in a manner in which user access is not cumbersome.

### SUMMARY

A computer implemented language interpretation/translation platform is provided. The computer implemented language interpretation/translation platform includes a receiver that receives a Session Initiation Protocol (“SIP”) packet. The SIP packet includes a request for a language interpretation/translation resource and a SIP header that stores identification data pertaining to the request. Further, the computer implemented language interpretation/translation platform includes a processor that selects the language interpretation/translation resource based on the identification data and routes the request to the selected language interpretation/translation resource.

Further, a computer program product is also provided. The computer program product includes a non-transitory computer readable storage device having a computer readable program stored thereon. When executed on a computer, the computer readable program causes the computer to receive, with a receiver, a SIP packet. The SIP packet includes a request for a language interpretation/translation resource and a SIP header that stores identification data pertaining to the request. Further, the computer is caused to select, with a processor, the language interpretation/translation resource based on the identification data and route the request to the selected language interpretation/translation resource.

In addition, a computing device is provided. The computing device includes a processor that generates a SIP packet. The SIP packet includes a request for a language interpretation/translation resource and a SIP header that stores identification data pertaining to the request. Further, the computing device includes a transmitter that sends the request to a routing engine that selects the language interpretation/translation resource based on the identification data and routes the request to the selected language interpretation/translation resource.

A computer implemented language interpretation/translation platform is also provided. The computer implemented language interpretation/translation platform includes a receiver that receives a SIP packet from a computing device through a Voice Over Internet Protocol (“VOIP”) network and identification data pertaining to a request for a language interpretation/translation resource from a web server. The SIP packet includes a unique identifier that is associated with the identification data. Further, the computer implemented language interpretation/translation platform includes a transmitter that sends the unique identifier to the web server to retrieve the identification data from a database. In addition, the computer implemented language interpretation/translation platform includes a processor that selects the language interpretation/translation resource based on the identification data and routes the request to the selected language interpretation/translation resource.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a language interpretation/translation configuration.

FIG. 2 illustrates an example of a SIP packet that may be sent by the computing device illustrated in FIG. 1 to the language interpretation/translation platform via the VOIP network.

FIG. 3 illustrates a language interpretation/translation configuration that may be utilized as an alternative to the language interpretation/translation configuration illustrated in FIG. 1.

FIG. 4 illustrates the internal components of the routing engine illustrated in FIG. 1.

FIG. 5 illustrates a process that may be utilized to generate a request for a language interpretation/translation resource illustrated in FIG. 1.

### DETAILED DESCRIPTION

An identification configuration identifies data pertinent to a request for language interpretation/translation services based on SIP. For example, the data pertinent to the request for language interpretation/translation services may be an account identifier, i.e., an identifier that identifies the requestor, and a language identifier, i.e., an identifier that identifies the language for which the requestor is requesting interpretation/translation resources. Such data is included in the header of the SIP packet that is sent via a communication between the requestor and a computer implemented language interpretation/translation platform. The computer implemented language interpretation/translation platform then utilizes the information to route the communication to a particular language interpretation/translation resource without the user having to manually provide such information, e.g., via voice inputs, keypad inputs, etc.

The identification configuration improves the functionality of a computer by increasing the processing speed of the computer implemented language interpretation/translation platform. Rather than having to determine the identity of the user and the requested language, which may lead to significant delays in routing the request to a corresponding language interpretation/translation resource, the computer implemented language interpretation/translation platform may retrieve such information from one or more SIP header packets sent from a computing device associated with the requestor. As a result, the processing speed of the computer implemented language interpretation/translation platform is increased.

Further, the identification configuration improves the functionality of a computer by improving the accuracy of the computer implemented language interpretation/translation platform. Rather than relying on an IVR, which may or may not accurately obtain data pertinent to the request from the requestor, the computer implemented language interpretation/translation platform is able to accurately obtain data as provided by the requestor in a SIP header packet. As a result, the accuracy of the computer implemented language interpretation/translation platform is increased.

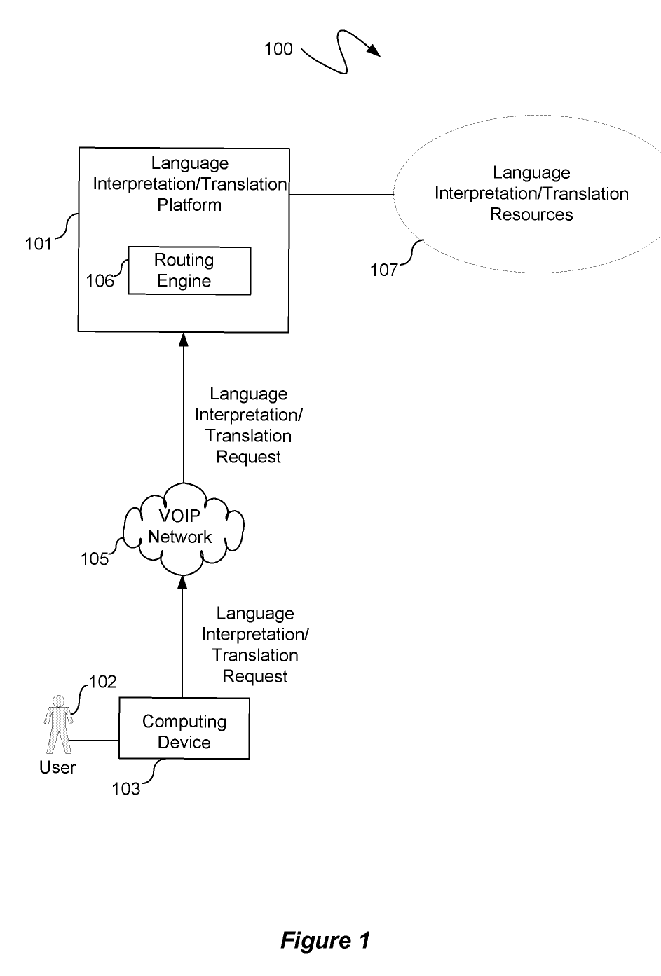

FIG. 1 illustrates a language interpretation/translation configuration 100. The language interpretation/translation configuration 100 includes a language interpretation/translation platform 101 that communicates with a computing device 103 via a VOIP network 105. For instance, the audio transport layer of VOIP may be utilized by the user 102 to request a language/interpretation resource 107, e.g., a human language interpreter/translator, machine language interpreter/translator, etc. The computing device 103 may be a personal computer (“PC”), laptop computer, tablet device, smartphone, smart watch, etc. Further, the VOIP network 105 is illustrated only as an example as other types of networks may be utilized.

The VOIP network 105 allows the computing device 103 to send communications to the language interpretation/translation platform 101 via SIP packets. Further, the computing device 103 customizes the header information of one or more SIP packets sent to the language interpretation/translation platform 101 to include identification data pertinent to the language interpretation/translation request, e.g., an account identifier, a language identifier, etc.

A routing engine 106 of the language interpretation/translation platform 101 routes the language interpretation/translation received through the VOIP network 105 to a corresponding language interpretation/translation resource 107 based on the identification data. For instance, a user account number may be identified for billing purposes. Further, a language identifier may identify a particular language for language interpretation/translation so that the routing engine 106 may route the language interpretation/translation request to a language interpretation/translation resource 107 that has the corresponding skill, knowledge, etc. to provide a language interpretation/translation service in the requested language. In various embodiments, the routing engine 106 may be an IVR. In various other embodiments, the routing engine 106 may perform routing functionality without an IVR.

The identification data may include a variety of other data such as user preferences. For example, the user preferences may provide information as to a particular skill level, experience level, geographical proximity, human or machine language interpreter/translator, etc. The routing engine 106 may then search for an available language interpretation/translation resource based on such preferences.

In addition, the identification data may include data such as a particular modality for communication, e.g., voice, text, video, audio, etc. The routing engine 106 may then search for an available language interpretation/translation resource based on the requested modalities.

In various embodiments, the computing device 103 may have a storage device that stores a software application that is utilized by the user 102 to preconfigure and/or select the identification data. For example, the identification data may be preconfigured by the user 102 to store account information so that that the user 102 does not have to enter the account information each time that the user 102 sends a request for a language interpretation/translation resource 107 illustrated in FIG. 1. In other words, the application may be programmed to automatically retrieve the account information and insert that account information into a SIP packet header each time the user 102 sends a request for a language interpretation/translation resource 107 illustrated in FIG. 1. Other identification data may be preconfigured such as language selection, user preferences, modality preferences, etc. The software application may display such preconfigured data prior to sending the SIP packet to the language interpretation/translation platform 101 to allow the user 102 to modify as necessary.

In various other embodiments, the user 102 may provide one or more inputs corresponding to a selection of a language for language interpretation/translation. The user 102 may provide the one or more inputs via the software application stored by the computing device 103. As an example, the user 102 may select the language Spanish via a menu displayed by the computing device 103, e.g., a tablet device. As the language interpretation/translation session is established though a SIP telephone call to the language interpretation/translation platform 101 from the user 102, the account identifier for the user 102 and the language identifier for Spanish are passed by the application through a customized SIP header in a SIP packet. The account identifier and the language identifier are read by the routing engine 106, which then utilizes the account identifier and/or the language identifier to route the SIP telephone call to the language interpretation/translation resource 107, e.g., language interpreter/translator, corresponding to the language identifier.

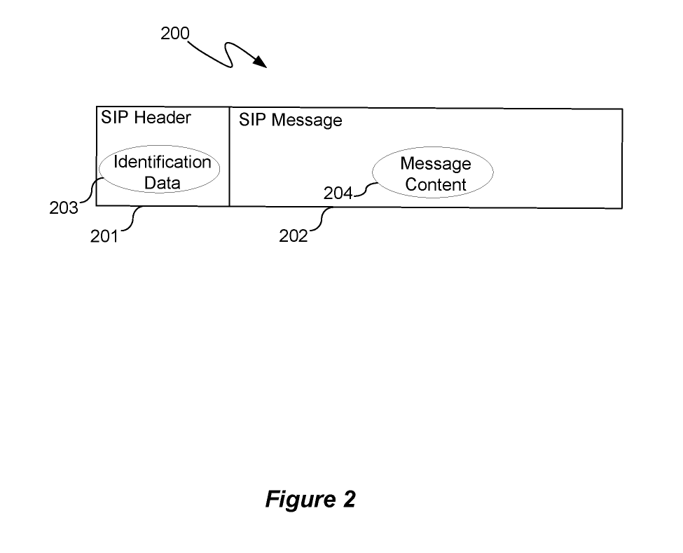

FIG. 2 illustrates an example of a SIP packet 200 that may be sent by the computing device 103 illustrated in FIG. 1 to the language interpretation/translation platform 101 via the VOIP network 105. The SIP packet 200 has a SIP header 201 and a SIP message 202. The SIP header 201 may be customized by the computing device 103 to include the identification data 203, e.g., account identifier, language identifier, etc. Further, the SIP message 202 includes message content 204, which may include the content of the communication sent from the computing device 103 to the language interpretation/translation platform 101.

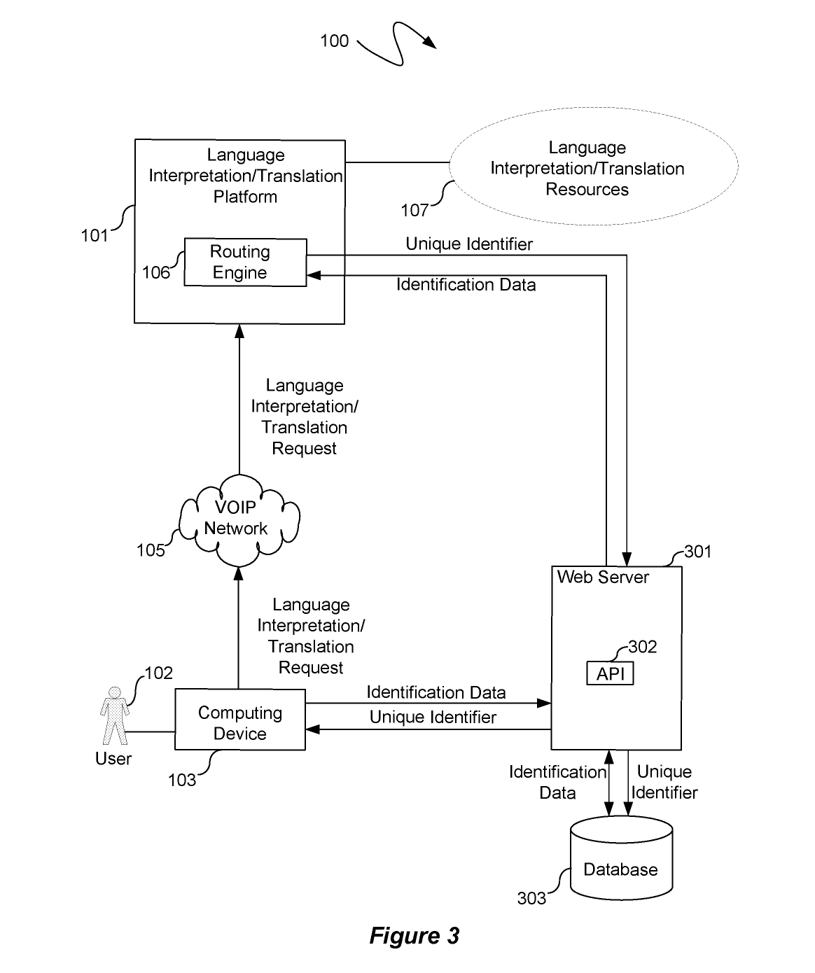

FIG. 3 illustrates a language interpretation/translation configuration 300 that may be utilized as an alternative to the language interpretation/translation configuration 100 illustrated in FIG. 1. The computing device 103 sends the identification data to a web server 301 through an Application Programming Interface (“API”) 302. The API 302, e.g., a web services API, or other application stored on the web server 301 generates a unique identifier for the identification data. The API 302 or other application stored on the web server 301 stores the identification data and the unique identifier in a database 303, e.g., a cloud database. In other words, the identification data is stored according to the unique identifier in the database 303 for subsequent retrieval. Further, the API 302 then sends the unique identifier to the computing device 103.

The computing device 103 includes the unique identifier in the SIP header 201 as the identification data or in addition to identification data that may not have been stored in the database 303. The computing device 103 then sends the SIP packet 200 to the routing engine 106 of the language interpretation/translation platform 101. Further, the routing engine 106 obtains the unique identifier from the SIP header 201. In addition, the routing engine 106 sends the unique identifier to the web server 301 to retrieve the identification data from the database 303. The web server 301 then sends the identification data to the routing engine 106, which may then utilize the identification data to route the request from the user 102 to a corresponding language interpretation/translation resource 107 according to the language identifier, user preferences, etc.

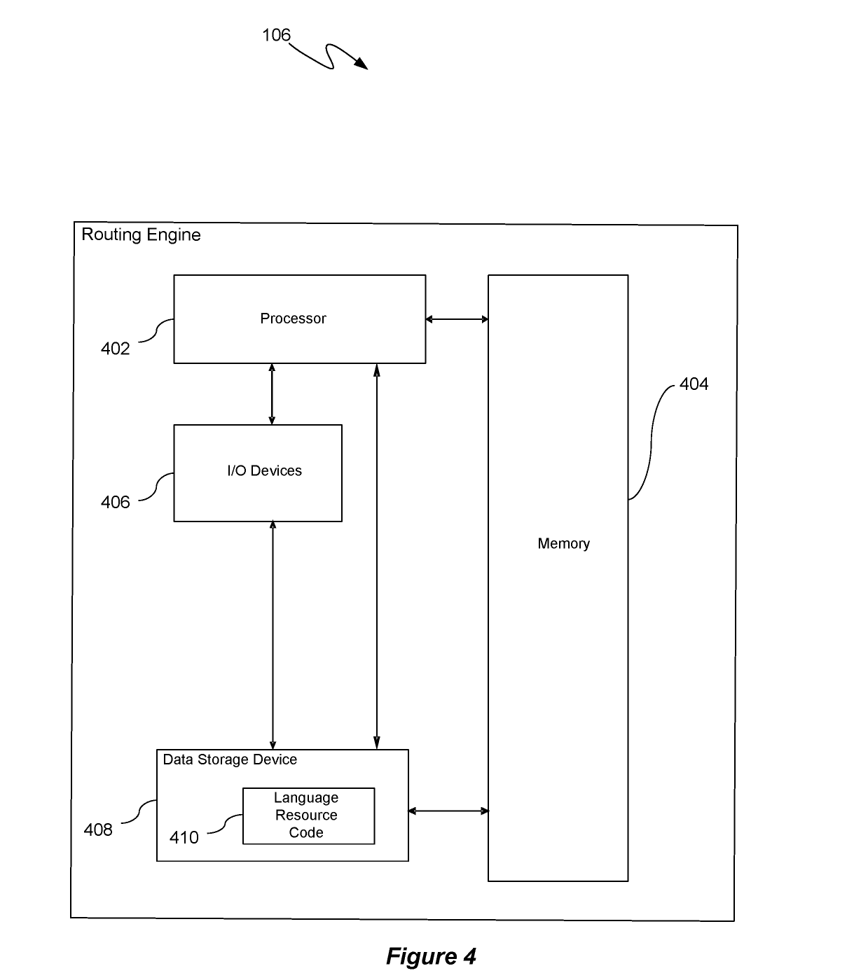

FIG. 4 illustrates the internal components of the routing engine 106 illustrated in FIG. 1. In one embodiment, the routing engine 106 is implemented utilizing a general purpose computer or any other hardware equivalents. Thus, the routing engine 106 comprises a processor 402, a memory 404, e.g., random access memory (“RAM”) and/or read only memory (“ROM”), various input/output devices 406, e.g., a receiver, a transmitter, a user input device, a speaker, an image capture device, an audio capture device, etc., a data storage device 408, and language resource code 410 stored on the data storage device 408. The language resource code 410 is utilized by the processor 401 to determine the availability of various language interpretation/translation resources 107, e.g., determination of whether or not a resource is online, working on another project, etc.

The language resource code 410 may be represented by one or more software applications or a combination of software and hardware, e.g., using application specific integrated circuits (“ASIC”), where the software is loaded from a storage device such as a magnetic or optical drive, diskette, or non-volatile memory and operated by the processor 402 in the memory 404 of the computer. As such, the language resource code 410 and associated data structures may be stored on a computer readable medium such as a computer readable storage device, e.g., RAM memory, magnetic or optical drive or diskette, etc. The routing engine 106 may be utilized for a hardware implementation of any of the configurations provided herein.

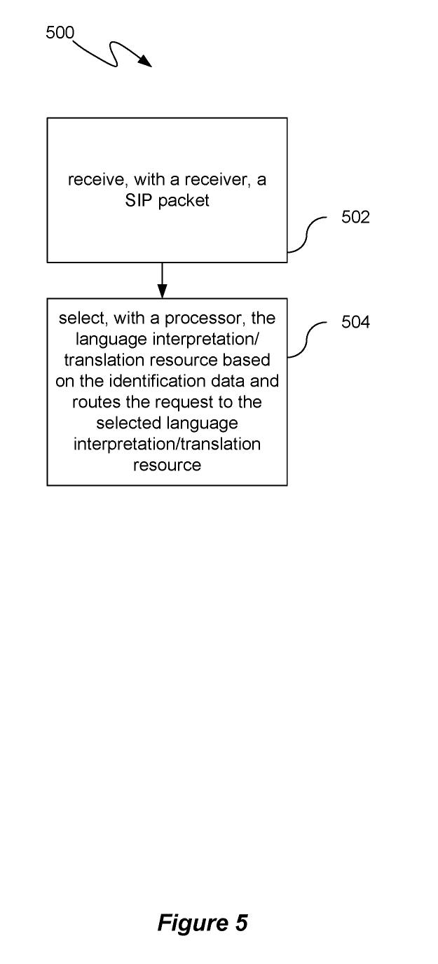

FIG. 5 illustrates a process 500 that may be utilized to generate a request for a language interpretation/translation resource 107 illustrated in FIG. 1. At a process block 502, the process 500 receives, with a receiver, a SIP packet. The SIP packet includes a request for a language interpretation/translation resource and a SIP header that stores identification data pertaining to the request. Further, at a process block 504, the process 500 selects, with a processor, the language interpretation/translation resource based on the identification data and route the request to the selected language interpretation/translation resource.

The processes described herein may be implemented in a specialized processor that is specifically configured to generate and/or read SIP header data. Alternatively, such processes may be implemented in a multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium such as a computer readable storage device. The instructions may also be created using source code or any other known computer-aided design tool. A computer readable medium may be any medium capable of storing those instructions and include a CD-ROM, DVD, magnetic or other optical disc, tape, silicon memory, e.g., removable, non-removable, volatile or non-volatile, etc..

A computer is herein intended to include any device that has a general, multi-purpose or single purpose processor as described above. For example, a computer may be a PC, laptop computer, set top box, cell phone, smartphone, tablet device, portable media player, video player, etc.

The described configurations allow the language interpretation/translation platform 101 to obtain identification data pertinent to selecting a language interpretation/translation resource 107 without any need for the user 102 to provide such inputs during a telephone call. As a result, the user may bypass much of the data entry process to get more quickly connected to the selected language interpretation/translation resource 107.

Portions of the SIP packet structure other than the SIP header 201 may be utilized to send the identification data 203 from the computing device 103 to the language interpretation/translation platform 101. For example, the identification data 203 may be sent by the computing device 103 as part of a SIP URL parameter. As another example, the identification data 203 may be sent by the computing device 103 as part of a SIP URL endpoint. As yet another example, the identification data 203 may be sent by the computing device 103 in the user portion of the SIP packet, which may also be referred to as the phone number portion. The user portion of the SIP packet may be utilized to send data to a smart switch that routes the request for the language interpretation/translation resource 107 without asking for data from a customer. Any of the described SIP portions may be utilized individually or in combination with the SIP header 201. For example, some of the identification data may be sent via the SIP header whereas the remainder may be sent via the SIP URL parameter.

It is understood that the computer program products, apparatuses, systems, and processes described herein may also be applied in other types of apparatuses, systems, and processes. Those skilled in the art will appreciate that the various adaptations and modifications of the embodiments of the compute program products, apparatuses, systems, and processes described herein may be configured without departing from the scope and spirit of the present computer program products, apparatuses, systems, and processes. Therefore, it is to be understood that, within the scope of the appended claims, the present computer program products, apparatuses, systems, and processes may be practiced other than as specifically described herein.

We claim:

1. A computer implemented language interpretation/translation platform comprising:
a receiver that receives a SIP packet, the SIP packet including a request for a language interpretation/translation resource and a SIP header that stores identification data pertaining to the request; and
a processor that selects the language interpretation/translation resource based on the identification data and routes the request to the selected language interpretation/translation resource.

2. The computer implemented language interpretation/translation platform of claim 1, wherein the identification data includes an account identifier.

3. The computer implemented language interpretation/translation platform of claim 1, wherein the identification data includes a language identifier.

4. The computer implemented language interpretation/translation platform of claim 1, wherein the identification data includes a user preference for a language interpretation/translation session.

5. The computer implemented language interpretation/translation platform of claim 1, wherein the identification data includes a modality preference for a modality of communication for a language interpretation/translation session.

6. The computer implemented language interpretation/translation platform of claim 6, wherein the modality preference is selected from the group consisting of video, voice, text, and audio.

7. The computer implemented language interpretation/translation platform of claim 1, wherein the identification data is stored in the SIP header by a computing device that sends the SIP packet.

8. A computer program product comprising a non-transitory computer readable storage device having a computer readable program stored thereon, wherein the computer readable program when executed on a computer causes the computer to:
receive, with a receiver, a SIP packet, the SIP packet including a request for a language interpretation/translation resource and a SIP header that stores identification data pertaining to the request; and
select, with a processor, the language interpretation/translation resource based on the identification data and routes the request to the selected language interpretation/translation resource.

9. The computer program product of claim 8, wherein the identification data includes an account identifier.

10. The computer program product of claim 8, wherein the identification data includes a language identifier.

11. The computer program product of claim 8, wherein the identification data includes a user preference for a language interpretation/translation session.

12. The computer program product of claim 8, wherein the identification data includes a modality preference for a modality of communication for a language interpretation/translation session.

13. The computer program product of claim 12, wherein the modality preference is selected from the group consisting of video, voice, text, and audio.

14. The computer program product of claim 8, wherein the identification data is stored in the SIP header by a computing device that sends the SIP packet.

15. A computing device comprising:
a processor that generates a SIP packet, the SIP packet including a request for a language interpretation/translation resource and a SIP header that stores identification data pertaining to the request; and
a transmitter that sends the request to a routing engine that selects the language interpretation/translation resource based on the identification data and routes the request to the selected language interpretation/translation resource.

16. The computing device of claim 15, wherein the identification data includes an account identifier.

17. The computing device of claim 15, wherein the identification data includes a language identifier.

18. The computing device of claim 15, wherein the identification data includes a user preference for a language interpretation/translation session.

19. The computer implemented language interpretation/translation platform of claim 15, wherein the identification data includes a modality preference for a modality of communication for a language interpretation/translation session.

20. A computer implemented language interpretation/translation platform comprising:
a receiver that receives a SIP packet from a computing device through a VOIP network and identification data pertaining to a request for a language interpretation/translation resource from a web server, the SIP packet including a unique identifier that is associated with the identification data;
a transmitter that sends the unique identifier to the web server to retrieve the identification data from a database; and
a processor that selects the language interpretation/translation resource based on the identification data and routes the request to the selected language interpretation/translation resource.
